(19) United States
(12) Patent Application Publication
(10) Pub. No.: US 2011/0157912 A1
(43) Pub. Date: Jun. 30, 2011

(54) LIGHT GUIDE PLATE AND RELATED BACKLIGHT MODULE

(75) Inventors: HSI-CHANG WU, Tu-Cheng (TW); DA-WEI LIN, Tu-Cheng (TW)

(73) Assignee: HON HAI PRECISION INDUSTRY CO., LTD., Tu-Cheng (TW)

(21) Appl. No.: 12/756,124

(22) Filed: Apr. 7, 2010

(30) Foreign Application Priority Data
Dec. 30, 2009 (TW) 98146060

(51) Int. Cl. F21V 7/04; F21V 8/00

(52) U.S. Cl. 362/606; 362/317

(57) ABSTRACT

An array of first micro-structures is formed on a bottom surface of a light guide plate and a number of randomly positioned second micro-structures are formed on an emitting surface of the light guide plate substantially opposite to the bottom surface. The first micro-structure is larger than the second micro-structure. The density of the first micro-structures is smaller than that of the second micro-structures.

### BACKGROUND

1. Technical Field

The present disclosure relates to light guide plates and, particularly, to a light guide plate for emitting high uniformity light rays and a backlight module having the light guide plate.

2. Description of Related Art

Light guide plates are widely used in backlight modules of liquid crystal displays (LCDs). Such light guide plates can efficiently guide/direct light rays along a desired direction/path. However, uniformity of the light rays is often less than satisfactory.

Therefore, it is desirable to provide a light guide plate and a backlight module, which can overcome the abovementioned limitations.

### BRIEF DESCRIPTION OF THE DRAWINGS

Many aspects of the present light guide plate and backlight module should be better understood with reference to the following drawings. The components in the drawings are not necessarily drawn to scale, the emphasis instead being placed upon clearly illustrating the principles of the present light guide plate and backlight module. Moreover, in the drawings, like reference numerals designate corresponding parts throughout the several views.

FIG. 1 is an isometric view of a light guide plate, according to one embodiment.

FIG. 2 is similar to FIG. 1, but viewed from another angle.

FIG. 3 is a side view of the light guide plate of FIG. 1.

FIG. 4 is a side view of a backlight module, according to another embodiment.

### DETAILED DESCRIPTION

Embodiments of the present light guide plate and backlight module will now be described in detail with reference to the drawings.

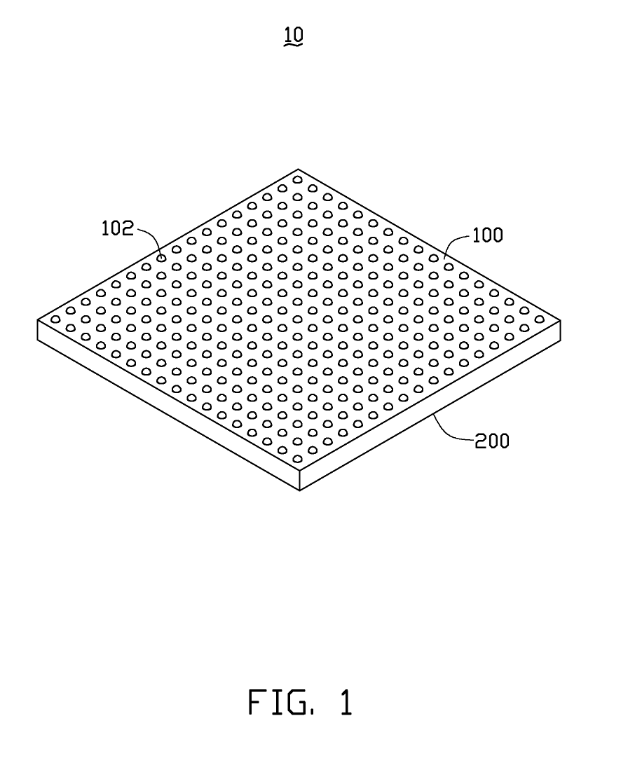

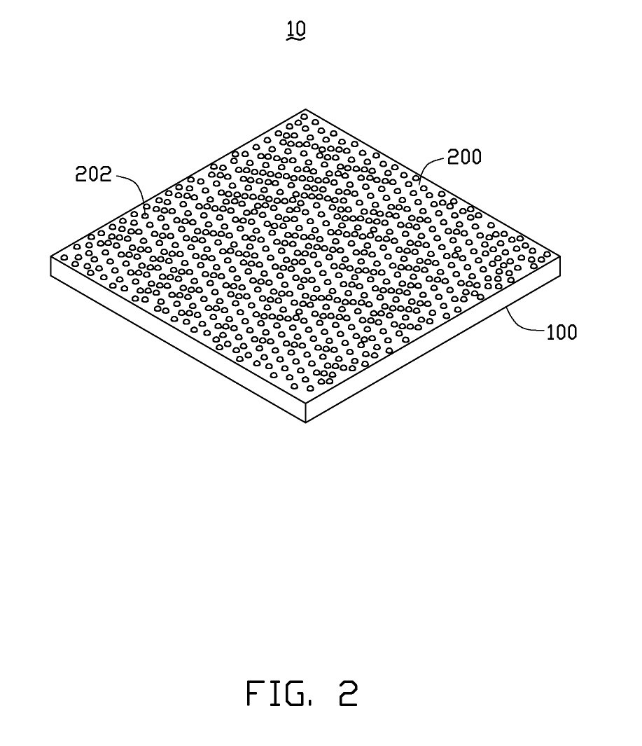

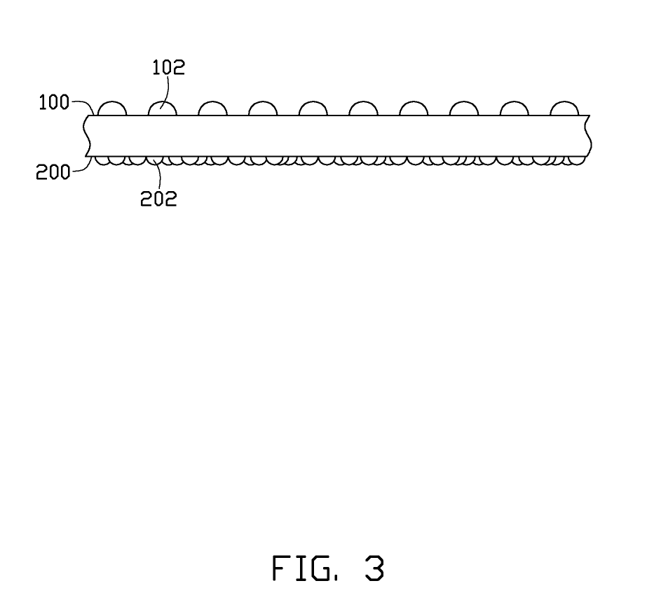

Referring to FIGS. 1-3, a light guide plate 10, according to one embodiment, includes a bottom surface 100 and an emitting surface 200 substantially opposite to the bottom surface 100. An array of first micro-structures 102, such as dot-shaped protrusions or recesses, is formed on the bottom surface 100, and a number of randomly arranged second micro-structures 202, such as dot-shaped protrusions or recesses are formed on the emitting surface 200. The first micro-structures 102 are larger than the second micro-structures 202. The density of the first micro-structures 102 is smaller than that of the second micro-structures 202.

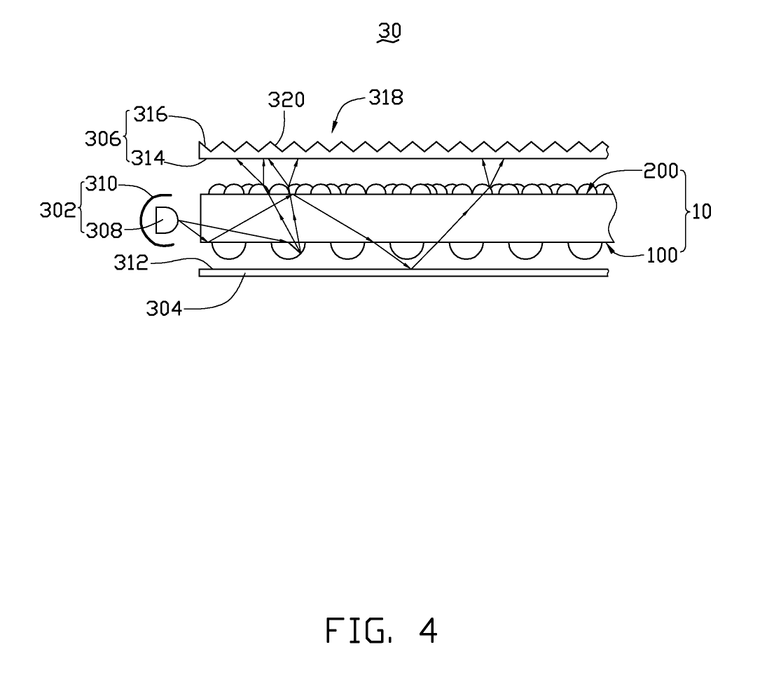

Referring to FIG. 4, a backlight module 30, according to another embodiment, includes a light source assembly 302, a reflecting plate 304, the light guide plate 10, and a prism array plate 306.

The light source assembly 302 includes a light source 308 such as a cold cathode tube and a reflector 310. The light source 308 extends along a light incident surface of the light guide plate 10 that is interconnected between the bottom surface 100 and the emitting surface 200. The reflector 310 also extends along the light incident surface of the light guide plate 10 and has a parabolic profile. The reflector 310 is configured to reflect light rays emitted from the light source 308 to the light incident surface of the light guide plate 10.

The light reflecting plate 304 has a reflecting surface 312 coated with high-reflective material such as polyethylene terephthalate (PET). The light reflecting plate 304 is positioned beneath and arranged parallel to the bottom surface 100. The reflecting surface 312 directly faces the bottom surface 100.

The prism array plate 306 includes a mirror surface 314 and a toothed prism surface 316. The prism surface 316 defines a number of grooves 318, each of which is bound by two angled connecting surfaces 320. The prism array plate 306 is positioned above and arranged parallel to the emitting surface 200. The mirror surface 314 directly faces the emitting surface 200.

In use, light rays emitted from the light source 308 are directed to the bottom surface 100 via the reflector 310. Some of the light rays are reflected by the large-sized first micro-structures 102. The other light rays pass the bottom surface 100 and are reflected back to the bottom surface 100 by the reflecting surface 312 and dispersed (refracted) by the micro-structures 102. The light rays are first coarsely uniformized by the first micro-structures 102. Then the light rays are directed to the emitting surface 200 and dispersed by the second micro-structures 202. Thereby, the light rays become more uniformity. Finally, the light rays are further dispersed by the prism array plate one more time to obtain an excellent uniformity.

It will be understood that the above particular embodiments and methods are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A light guide plate comprising:
a bottom surface;
an array of first micro-structures arranged on the bottom surface;
a light emitting surface substantially opposite to the bottom surface; and
a number of irregularly arranged second micro-structures; the first micro-structure being larger than the second micro-structure; the distribution density of the first micro-structures being smaller than that of the second micro-structures.

2. The light guide plate of claim 1, wherein the first micro-structures are selected from the group consisting of dot-shaped protrusions and dot-shaped recesses.

3. The light guide plate of claim 1, wherein the second micro-structures are selected from the group consisting of dot-shaped protrusions and dot-shaped recesses.

4. A backlight module comprising:
a light guide plate comprising:
a bottom surface;
an array of first micro-structures arranged on the bottom surface;
a light emitting surface substantially opposite to the bottom surface; and
a number of irregularly arranged second micro-structures; the first micro-structure being larger than the second micro-structure; the distribution density of the first micro-structures being smaller than that of the second micro-structures;
a light source assembly for emitting and directing light rays toward the bottom surface; the first micro-structures being configured for reflecting and diffusing a portion of the light rays; the bottom surface configured for transmitting a remaining portion of the light rays therethrough;
a reflecting plate positioned facing the bottom surface for reflecting the remaining portion of the light rays back to the bottom surface; the first micro-structures being configured for transmitting the remaining light rays therethrough; the second micro structures being configured for transmitting and diffusing the light rays from the bottom surface to the light emitting surface; and
a prism array plate positioned facing the emitting surface and configured for diffusing the light rays from the light emitting surface.

5. The backlight module of claim 4, wherein the light source assembly comprises a light source and a reflector, the light source and the reflector extending along a light incident surface of the light guide plate interconnected between the bottom surface and the light emitting surface; the reflector having a parabolic profile and being configured to direct the light rays from the light source to the light incident surface of the light guide plate.

6. The backlight module of claim 5, wherein the light source comprise a cold cathode tube.

7. The backlight module of claim 4, wherein the light reflecting plate comprises a reflecting surface coated with high-reflective material.

8. The backlight module of claim 7, wherein the high-reflective material comprises polyethylene terephthalate.

9. The backlight module of claim 7, wherein the light reflecting plate is positioned beneath and arranged parallel to the bottom surface, the reflecting surface being adjacent to and facing the bottom surface.

10. The backlight module of claim 4, wherein the prism array plate comprises a mirror surface and a toothed prism surface, the prism surface comprising a plurality of grooves, each of which is bound by two angled connecting surfaces; the prism array plate being positioned above and arranged parallel to the light emitting surface; the mirror surface being adjacent to and facing the emitting surface.

11. The backlight module of claim 4, wherein the first micro-structures are selected from the group consisting of dot-shaped protrusions and dot-shaped recesses.

12. The backlight module of claim 4, wherein the second micro-structures are selected from the group consisting of dot-shaped protrusions and dot-shaped recesses.
